(19) United States
(12) Patent Application Publication
(10) Pub. No.: US 2020/0387134 A1
(43) Pub. Date: Dec. 10, 2020

(54) BALANCE ADJUSTMENT METHOD FOR LIFTING PLATFORM

(71) Applicant: LOCTEK ERGONOMIC TECHNOLOGY CORP., NINGBO (CN)

(72) Inventors: Lehong XIANG, NINGBO (CN); Xiang LI, NINGBO (CN); Jiadong JIN, NINGBO (CN)

(21) Appl. No.: 16/888,607

(22) Filed: May 29, 2020

(30) Foreign Application Priority Data
Jun. 10, 2019 (CN) 201910494911.7

(51) Int. Cl. G05B 19/402; B66F 17/00

(52) U.S. Cl. CPC G05B 19/402; A47B 9/02; B66F 17/00

(57) ABSTRACT

The present invention relates to the technical field of lifting platforms, in particular to a balance adjustment method for a lifting platform. By detecting the inclination to judge whether the platform is inclined, and then adjusting the lifting mechanism for balance adjustment; this adjustment method can automatically adjust the inclination of the lifting platform.

### CROSS-REFERENCE TO RELATED APPLICATIONS

This application claims priority to Chinese Patent Application No. 201910494911.7 with a filing date of Jun. 10, 2019. The content of the aforementioned applications, including any intervening amendments thereto, are incorporated herein by reference.

### TECHNICAL FIELD

The present invention relates to the technical field of lifting platforms, in particular to a balance adjustment method for a lifting platform.

### BACKGROUND

A lifting platform, in the form of a height-adjustable dining table, an office table, a medical bed, a scaffold or the like, can be easily found in houses, offices, hospitals, building sites, etc.

However, uneven placement of the lifting platform may cause its imbalanced platform top. As the lifting platform in the prior art lacks of an automatic inclination adjustment function, once the imbalance issue occurs, a user would suffer inconvenience and discomfort in use, and even if the angle of inclination is too large, articles on the platform or the user standing on the platform may fall off from the lifting platform.

### SUMMARY

The technical problem to be resolved by the present disclosure is to provide a balance adjustment method for a lifting platform whereby the inclination of a lifting platform can be automatically adjusted.

The technical solution of the present disclosure discloses a balance adjustment method for a lifting platform. A lifting platform comprises a controller, an inclination sensor and at least two groups of lifting mechanisms arranged at two opposite sides of the lifting platform, and the inclination sensor and the lifting mechanisms are in signal connection with the controller. The balance adjustment method for a lifting platform comprises the following steps:

S1, detecting with the controller whether an inclination adjustment signal is received or not, if the inclination adjustment signal is not detected, continuing to detect, and if the inclination adjustment signal is detected, skipping to next step;

S2, detecting with the controller whether the lifting mechanisms are still, if detecting that the lifting mechanisms are in operation, returning to S1 to continue detecting, and if detecting that the lifting mechanisms are still, skipping to next step;

S3, detecting with the inclination sensor the inclination of the lifting platform and sending the detected inclination to the controller, comparing the detected inclination with a set inclination threshold by the controller, if the detected inclination exceeds a set threshold A1, skipping to next step; if the detected inclination is less than or equal to the set threshold A1, skipping to S1 to continue detecting;

S4, controlling with the controller ascending or descending of the lifting mechanism at a first side while continuing to detect with the inclination sensor, and if the detected inclination is less than that detected in S3, skipping to next step; if the detected inclination is more than or equal to that detected in S3, controlling the lifting mechanism at the first side to move in a reverse direction, and then skipping to next step; and

S5, continuing to detect the inclination with the inclination sensor, and when the detected inclination is less than or equal to the set threshold A1, controlling all lifting mechanisms to stop operation.

By adopting the above method, the present invention has the following advantages as compared with the prior art: the inclination sensor detects the inclination of the lifting platform when it is still, and then adjustment is carried out based on the detected inclination, therefore, automatic adjustment is achieved with great convenience and high accuracy. In the process of mounting the lifting platform having two groups of legs, it is easy for a user to insert cables into wrong interfaces of the two groups of legs in a lifting control box, even so balance adjustment of the platform still can be achieved by using the method.

Preferably, in S5, when the detected inclination is less than a deceleration threshold A2, the controller controls the lifting mechanism in operation to decelerate. A2 is more than A1. Setting a deceleration threshold favors of decelerating the lifting mechanism when a balanced position is about to arrive in the adjustment process so as to prevent excessive adjustment, thereby having high adjustment accuracy.

Preferably, after the controller controls the lifting mechanism in operation to decelerate, the inclination sensor continues to detect the inclination, and when the detected inclination is less than a stopping threshold A3, the controller controls the lifting mechanism in deceleration to stop operation. A3 is less than A2. Due to the set stopping threshold, the lifting mechanism, i.e., the motor is closed when the platform top approaches to the horizontal surface. Inertia of the motor helps the platform top become horizontal, so that adjustment accuracy is high.

Preferably, in S4, the controller controls the lifting mechanism at the first side to ascend and the lifting mechanism at a second side to descend, meantime the inclination sensor continues to detect, and if the detected inclination is less than that detected in S3, operation skips to S5; if the detected inclination is more than or equal to that detected in S3, the lifting mechanism at the first side is controlled to descend and the lifting mechanism at the second side is controlled to ascend at the same time, and operation skips to S5. The lifting mechanisms at two sides are simultaneously adjusted, thus adjustment efficiency is higher.

Preferably, if the lifting mechanism at either side arrives at the limit position, the lifting mechanism at this side stops operation, and then only the lifting mechanism at the other side is controlled to operate. During adjustment, once at the top or bottom end, the lifting mechanism cannot ascend or descend any more, in such a case, only the lifting mechanism at the other side can be unilaterally adjusted, therefore, the lifting mechanisms are prevented from being damaged in adjustment.

Preferably, in S4, the controller controls the lifting mechanism to operate at the speed of X, and then at the speed of Y when the detected inclination is less than that detected in S3. Y is greater than X. A lower speed is set in judging the inclining side while a higher speed is preferred in adjustment, thereby improving adjustment efficiency.

Preferably, a factory setting levelness A0 is detected before S1. Considering consistency in the aspects of production process and artificial assembly, when the inclination sensor is mounted on a circuit board or the circuit board is placed in a control box in each product, there is an issue of levelness inconsistency in assembling the inclination sensor, therefore debugging is necessary before delivery, that is, a lifting platform is placed horizontally, and then the value of the inclination sensor at this moment is detected and taken as the horizontal reference.

Preferably, in S4, the relationship between the inclination and the adjustment direction also needs to be recorded. To prevent frequent insertion, detection on direction in S4 is necessary, this direction can be recorded after once detection and then adjustment is carried out in accordance with the detected inclination value along the recorded direction, therefore, other detection on direction is avoided, and adjustment becomes easy.

Preferably, the inclination sensor may be an acceleration sensor or angle sensor by which the inclination is conveniently detected, and detection accuracy is higher.

### EMBODIMENTS

The present disclosure will be further described in the following embodiments, but is not limited thereto.

Embodiment One: a lifting table comprises a controller, a table board, lifting mechanisms at two sides of the lower part of the table board, an inclination sensor and an input module. The lifting mechanisms, the inclination sensor and the input module are in signal connection with the controller. The lifting mechanisms are often used in the field of lifting tables, mainly comprise lifting legs and motors, and thus will not be repeated any more. The inclination sensor is mainly used for detecting the whole inclination, may adopt an acceleration sensor or other sensors and will not be explained in detail as it is a conventional technology.

If the input module is a conventional key module, a user inputs a control signal via keys, or if it is a remote control module, a user emits a signal via a remote control, and the signal is delivered through a wireless communication module to realize control. As a conventional component, any detailed information about the input module will not be provided.

The controller used in the embodiment is very common in the field of lifting tables, and mainly used for processing input information and detection information, comparing with a pre-stored value, and controlling the lifting mechanisms to operate.

A lifting table balance adjustment method mainly comprises the following steps:

S1, detecting inclination by placing a lifting table on a flat ground before delivery to obtain factory levelness A0 serving as the horizontal reference, delivering the lifting table from the factory, and placing the lifting table at the required position by a user;

S2, inputting an inclination adjustment signal by the user on the input module via keys if it is a key module or via a remote control if it is a remote control module;

S3, judging whether the lifting mechanisms are still or not at present by the controller; if they are not still, indicating that the lifting mechanisms at this moment are in operation and thus not fit for inclination adjustment; and if they are still, indicating that the lifting mechanisms at this moment are idle and fit for inclination adjustment;

S4, detecting with the inclination sensor the inclination of the lifting platform; if the absolute value of the difference of the detected inclination and the factory levelness A0 is more than a set threshold A1, indicating that inclination adjustment is needed; if the absolute value of the difference of the detected inclination and the factory levelness A0 is less than or equal to the set threshold A1, indicating that inclination adjustment is not needed. The set threshold A1 is typically within 0.1-2°, and is 1° in this embodiment.

S5, adjusting the inclination, i.e., controlling with the controller the lifting mechanism at one side to ascend and the lifting mechanism at the other side to descend at the same speed of X, simultaneously detecting with the inclination sensor once again; if the absolute value of the difference of the detected inclination and the factory levelness A0 becomes lower, indicating that the adjusting direction is correct, controlling the lifting mechanisms to continuously operate, and adjusting the speed to Y that is equal to 2X; if the absolute value of the difference of the detected inclination and the factory levelness A0 becomes higher, indicating that the adjustment direction is wrong, then controlling the two lifting mechanisms to operate in respective reverse direction, and adjusting the speed to Y which is equal to 2X; recording the adjustment direction based on the positive or negative difference, if the difference of the detected inclination and the factory levelness A0 is positive, indicating that such adjustment of controlling the lifting mechanism at one side to ascend and the lifting mechanism at the other side to descend is correct, and if the difference of the detected inclination and the factory levelness A0 is negative, indicating that such adjustment of controlling the lifting mechanism at one side to descend and the lifting mechanism at the other side to ascend is correct, or adjustment in reverse direction is correct. When arriving at the limit position in the moving process, the lifting mechanism needs to stop operation, for example, the lifting table is at the top, the lifting mechanisms at two sides cannot move upward any more, in such a case, only the lifting mechanism at either side descends for adjustment.

S6, continuing to detect with the inclination sensor; if the absolute value of the difference of the detected inclination and the factory levelness A0 is less than a deceleration threshold A2, decelerating the two lifting mechanisms. The deceleration threshold A2 in this embodiment is 2°;

S7, continuing to detect with the inclination sensor; if the absolute value of the difference of the detected inclination and the factory levelness A0 is less than a stopping threshold A3, stopping the lifting mechanisms, that is, closing motors in the lifting mechanisms, and continuing to adjust by means of inertia of the motors. The stopping threshold A3 in this embodiment is 1.2°, therefore, when the motors completely stop under the effect of inertia, the absolute value of the difference of the detected inclination and the factory levelness A0 has been less than 1°, thereby completing once successful inclination adjustment.

As the lifting mechanisms generally operate at a higher speed, considering the high requirement on accuracy in adjustment, it needs to properly decelerate the lifting mechanisms to ensure adjustment accuracy. If the normal operation speed of the lifting mechanisms is set as Z, Z=2Y.

Embodiment Two: a scaffold comprises a controller, a standing platform, a lifting mechanism for adjusting height of the standing platform, an inclination sensor and an input module. The lifting mechanism, the inclination sensor and the input module are in signal connection with the controller. The lifting mechanism mainly comprising a motor differs from that of Embodiment One in higher motor power and shape of the attached lifting structure, but they have similar operation principle.

The inclination sensor is mainly used for detecting the whole inclination, and may adopt an acceleration sensor or other sensors. The inclination sensor as such a conventional technology will not be further explained.

The input module may be a conventional key module, that is, a user inputs a control signal via keys, or it is a remote control module, that is, a user emits a signal via a remote control, and the signal is delivered via a wireless communication module to realize control. With such a conventional technology, the input module will not be further described.

The controller is similar with that in Embodiment One, and they have the similar operation principle. Therefore, detailed description will not be provided.

A scaffold balance adjustment method comprises the specific steps as similar as those in Embodiment One, and merely differs in the requirement on accuracy, i.e., the accuracy in this embodiment is not so high as that in Embodiment One. Therefore, the set threshold is large and is 0.5-5° in the embodiment. Accordingly, the deceleration threshold and the stopping threshold are also large, and the stopping threshold of the scaffold can be lower, even lower than the set threshold, such as 0°. That is to say, after the lifting platform top is detected to be horizontal, the motor is closed.

It should be noted that, the above embodiments are merely illustrative, rather than restrictive, to the technical solution of the present invention. Although the present invention has been explained in detail by referring to the abovementioned embodiments, it should be understood by those skilled in the art that, modifications to the technical solutions in the embodiments or equivalent substitutions of portion of technical features are allowed. These modifications or substitutions shall not cause the corresponding technical solutions to depart from the spirit and scope of the technical solutions of the embodiments of the present invention.

We claim:

1. A balance adjustment method for a lifting platform, the lifting platform comprising a controller, an inclination sensor and at least two groups of lifting mechanisms arranged at two opposite sides of the lifting platform, and the inclination sensor and the lifting mechanisms are in signal connection with the controller, wherein, it comprises the following steps:
S1, detecting with the controller whether an inclination adjustment signal is received or not, if the inclination adjustment signal is not detected, continuing to detect, and if the inclination adjustment signal is detected, skipping to next step;
S2, detecting with the controller whether the lifting mechanisms are still, if detecting that the lifting mechanisms are in operation, returning to S1 to continue detecting, and if detecting that the lifting mechanisms are still, skipping to next step;
S3, detecting with the inclination sensor the inclination of the lifting platform and sending the detected inclination to the controller, comparing the detected inclination with a set inclination threshold by the controller, if the detected inclination exceeds a set threshold A1, skipping to next step; if the detected inclination is less than or equal to the set threshold A1, skipping to S1 to continue detecting;
S4, controlling with the controller ascending or descending of the lifting mechanism at a first side while continuing to detect with the inclination sensor, and if the detected inclination is less than that detected in S3, skipping to next step; if the detected inclination is more than or equal to that detected in S3, controlling the lifting mechanism at the first side to move in a reverse direction, and then skipping to next step; and
S5, continuing to detect the inclination with the inclination sensor, and when the detected inclination is less than or equal to the set threshold A1, controlling all lifting mechanisms to stop operation.

2. The balance adjustment method for a lifting platform of claim 1, wherein when the detected inclination is less than a deceleration threshold A2 in S5, the controller controls the lifting mechanism in operation to decelerate, and A2 is greater than A1.

3. The balance adjustment method for a lifting platform of claim 2, wherein after the controller controls the lifting mechanism in operation to decelerate, the inclination sensor continues to detect the inclination, and when the detected inclination is less than a stopping threshold A3, the controller controls the lifting mechanism in deceleration to stop operation; and A3 is less than A2.

4. The balance adjustment method for a lifting platform of claim 1, wherein the controller controls the lifting mechanism at the first side to ascend and the lifting mechanism at a second side to descend in S4, meanwhile the inclination sensor continues to detect, and if the detected inclination is less than that detected in S3, operation skips to S5; if the detected inclination is more than or equal to that detected in S3, the lifting mechanism at the first side is controlled to descend and the lifting mechanism at the second side is controlled to ascend at the same time, and operation skips to S5.

5. The balance adjustment method for a lifting platform of claim 4, wherein if the lifting mechanism at either side arrives at the limit position, the lifting mechanism at this side stops operation, and then only the lifting mechanism at the other side is controlled to operate.

6. The balance adjustment method for a lifting platform of claim 1, wherein in S4, the controller controls the lifting mechanism to operate at the speed of X, and then the controller controls the lifting mechanism at the speed of Y when the detected inclination is less than that detected in S3; Y is greater than X.

7. The balance adjustment method for a lifting platform of claim 1, wherein a factory setting levelness A0 is detected before S1.

8. The balance adjustment method for a lifting platform of claim 1, wherein the relationship between the inclination and the adjustment direction also needs to be recorded in S4.

9. The balance adjustment method for a lifting platform of claim 1, wherein the inclination sensor is an acceleration sensor or angle sensor.
